(19) United States
(12) Patent Application Publication
(10) Pub. No.: US 2009/0094843 A1
(43) Pub. Date: Apr. 16, 2009

(54) Escape cap

(76) Inventor: James Keith Brannam Brannam, Mission Viejo, CA (US)

Correspondence Address: BEN E. LOFSTEDT, P.O. BOX 4189, FULLERTON, CA, 92831, US

(21) Appl. No.: 12/288,140

(22) Filed: Oct. 16, 2008

Related U.S. Application Data
(60) Provisional application No. 60/980,364, filed on Oct. 16, 2007.

(51) Int. Cl. A62B 3/00; F21V 33/00

(52) U.S. Cl. 30/366; 362/119; 362/208; 362/457

(57) ABSTRACT

Escape cap is a flashlight tail cap that comes to a conical point for use as a poking weapon for delivering a concentrated bruising striking force to a flesh-covered body and for breaking glass, or glass-type, windows for access into or egress from a vehicle or the like.

### CROSS-REFERENCE TO RELATED APPLICATIONS

This invention is cross-referenced to a Provisional Patent Application, Application No. 60/980,364, filed Oct. 16, 2007, by Applicant James Keith Brannam, bearing Confirmation No. 1395, with a title “Escape Cap Is A Custom Flashlight Tail Cap that Comes to a Conical Point with a Hardened Insert that is Sufficient to Break Glass.”

### STATEMENT REGARDING FEDERALLY SPONSORED RESEARCH AGREEMENT

There is no federally sponsored research agreement concerning the aforementioned Provisional Patent Application, or pertaining to the subject matter described therein, or relative to the subject matter disclosed herein.

### THE NAMES OF THE PARTIES TO A JOINT RESEARCH AGREEMENT

There are no parties to a joint research agreement pertaining to the subject matter described in the Provisional Patent Application, or pertaining to the subject matter described therein, or relative to the subject matter disclosed herein.

### BACKGROUND OF THE INVENTION

(1) Field of the Invention

This invention relates generally to an add-on device to flashlights, and, more particularly, with flashlights which are not only used for lighting but for other purposes, such as self-defense and for breaking glass, such as windows in a motor vehicle to permit ingress and egress in an emergency.

(2) Description of Related Art Including Information Disclosed Under 37 CFR 1.97 and 1.98:

The applicant is aware of one prior art U.S. Pat. No. 6,199,997 B1 “Flashlight With A Safety Point and Method of Production Thereof” issued on Mar. 13, 2001 to Arthur C. Outsen and Daniel C. Outsen. This patent to Outsen teaches the use of a “safety point tip” which is pointed and sharp. A rubber cap is placed over the safety tip point “to avoid inadvertent contact with the tip by a user and any injury caused by such contact.” (Col. 2, Lines 24-27). The “safety point tip” of U.S. Pat. No. 6,199,997 B1 at the end of a “cone-shaped” body is sharp and requires a protective cover to prevent possible injury to the hand or body of the user.

Applicant's invention is referred to herein as an escape cap. The escape cap is a cap designed to replace the end cap of a flashlight covering the end of the flashlight opposite the light source end. The escape cap incorporates a conically shaped body having a base mateable with the end of the flashlight opposite the light source end and an apex with a receptacle therein. a small metal ball fixedly mounted in a receptacle in the apex of a conically contoured metal body. The base of the metal body is adapted to The small metal ball mounted at the apex of the cone-shaped body provides essentially a single point of tangential contact when placed in contact with the relatively flat surface of the glass it is intended to break similar to the sharp point disclosed by Outsen, but the rounded surface of the ball eliminates the need for a protective cap or covering for the apex. The base portion of the cone-shaped body is threadably secured to the opposite end of a flashlight.

Applicant is aware of another product/invention promoted by Todd Summers who claims to have been the original inventor of this same product as the Applicant's which is sold under the name of “Bust A Cap.” The product “Bust A Cap” is virtually identical to the Applicant's “Escape Cap” identified and disclosed in this present patent application. According to information found by the Applicant herein on the Internet, on Feb. 13, 2008, Bust A Cap, Inc. announced a new, one-of-a-kind device that attaches to an existing flashlight or baton that gives police officers, military and security personnel a tactical advantage in breaking glass windows. Bust A Cap is advertised as a rapid entry tool that was designed by a 13-year veteran of one of the largest Sheriff's Departments in the United States. This device is being utilized by law enforcement, fire departments, government agencies, private security and civilians around the world, giving them a tactical and safe entry or exit out of an automobile, house, boat or plane. By replacing the existing end cap on a flashlight or baton with a new Bust A Cap device, the user is able to easily make entry through glass windows. The device is manufactured in the United States and made from special steel and is described as applied to an existing flashlight or baton in less than a minute. It is further claimed that the use of the Bust A Cap requires no special training, and will break a glass window with one tap. According to http://www.otjgear.com, the Bust A Cap was created by a Police Officer for Police Officers. The address, according to the Internet at http://www.bustacap.net of Todd Summers, CEO, BUST A CAP, INC., 20292 Birch Street, Newport Beach, Calif. 92660; (949) 752 8100.

Based upon information and/or belief, Applicant understands that Todd Summers commenced marketing the product “Busta Cap” shortly following the Applicant's initial presentation of applicant's product in the public forum of a marital arts studio. Applicant disclosed this information to the United States Patent and Trademark Office on or about Dec. 7, 2007 via a letter addressed to the U.S. Patent Office, Director Art Unit #2870, P.O. Box 1450, Alexandria, Va. 22313, notifying the Director Art Unit-2870 of these facts. A copy of this letter is attached to this Utility patent application. On Dec. 8, 2007, this letter was mailed via U.S. Postal Service Certified Mail No. 7007 1490 0003 6426 5792, with return receipt requested. A copy of the Certified Mail Return Receipt is also provided as an attachment to the letter which is attached to this patent application.

### BRIEF SUMMARY OF THE INVENTION

The present invention uniquely consists of a small metal ball press-fitted into a receptacle forms in the apex of a cone-shaped body wherein the base of the body is adapted to be threadably secured to the end of a flashlight.

The use of a ball mounted in the apex of a cone-shaped body eliminates the risk of cutting the user's hand or body and does not require the use of a protective cover for the apex or tip of the cone-shaped body as taught by and disclosed in U.S. Pat. No. 6,199,997 B1 “Flashlight With A Safety Point and Method of Production Thereof” issued on Mar. 13, 2001 to Arthur C. Outsen and Daniel C. Outsen.

Alternatively, the ball can be securely mounted in the receptacle formed in the apex of the conically-shaped body by threadable engagement. Such threadable engagement would require a male thread about the body of the ball and a female thread about the wall of the receptacle formed in the apex or tip of the cone-shaped body.

A still further embodiment of the present invention disclosed by the Applicant herein is to radius the apex or tip of the cone-shaped body thereby eliminating the sharp tip of the cone-shaped body and the ball-and-receptacle combination of the other embodiment of the invention disclosed by the Applicant herein.

While the alternate embodiments of the present invention disclosed herein produce a similar structure, there are different benefits and characteristics realized by these two alternative embodiments of the Applicant's invention.

Applicant has discovered that the cone-shaped body can have two conical slopes to effectively shorten the overall depth of the cone-shaped body and reduce the amount of material needed to form the conically-shaped body. The first conical slope extending upwardly from the base towards the apex can be formed as having a relatively steeper slope than the slope of the outer portion of the second conically-shaped surface. Use of two conical slopes results in a reduction of the amount of material needed to form the body and also results in additional beneficial economies such as lowered material cost and weight reduction.

It is one object of the invention herein to eliminate the need for a protective cover or cap for the tip of the cone-shaped body of the within invention.

It is yet another object of the invention herein to allow the body of the invention to be formed of a material having reduced weight and hardness while forming the ball of a harder and more durable material for the breaking of glass, such as a window in a car or house for egress or access therethrough such as is often required in a given emergency situation.

Another object of the instant invention is to provide a custom flashlight tail cap tail cap with a cone-shaped body having a base and forming an apex at the end of the body oppositely disposed in spaced-apart relationship from the base with a hardened insert adapted for breaking glass when the insert is forceably impacted with the glass surface.

A yet still further object of the present invention is to provide a device attachable to the end of a flashlight for a use as a jabbing or poking weapon for delivering a concentrated bruising striking force to a flesh-covered body such as a person or an animal.

Another and yet still important object of the invention herein is to be used in combination with a flashlight as a defensive weapon to ward off an attacker.

The features of the present invention which are believed to be novel are set forth with particularity in the appended claims. Other claims and many of the attendant advantages will be more readily appreciated as the same becomes better understood by reference to the following detailed description and considered in connection with the accompanying drawings in which like reference symbols designate like parts throughout the figures.

### BRIEF DESCRIPTION OF THE SEVERAL VIEWS OF THE DRAWINGS

For a more complete understanding of the nature of the present invention, including other features and advantages of the present invention will become even more appreciated and understood with reference to the specification, claims and drawings and the following detailed description taken in connection with the accompanying drawings in which:

FIG. 1 generally depicts a flashlight with the present invention mounted as an end cap thereon.

FIG. 2 is a top end view of the present invention with a ball bearing mounted on the tip or apex of the external conically shaped body thereof.

FIG. 3 is a vertical elevational view of the present invention showing a partial cut-out depicting the threads about the inside of the base portion of the body used to threadably mate with the outside male threaded portion of the end of the flashlight.

FIG. 4 is an enlarged partial cutaway along Plane A-A of the invention shown in FIG. 3 showing a press-fitted ball bearing in the receptacle in the tip or apex of the cone-shaped body of the present invention.

FIG. 5 is an elevational view of an alternate embodiment of the present invention depicting a rounded tip or apex of the cone-shaped body of the present invention.

FIG. 6 is an enlarged partial cutaway similar to the cutaway shown in FIG. 4 along Plane A-A illustrating a yet still further embodiment of the present invention depicting a rod with a threaded end and a ball-shaped contour at the opposing end adapted to be threadably mated with the threaded receptacle in the tip or apex of the cone-shaped body of the present invention.

FIG. 7. is a assembly view depicting the present invention as it is threadably mated with the threaded end of the flashlight.

FIG. 8 is an enlarged view of the present invention adapted to be threadably mated to the threaded end of a flashlight depicting an O-ring seal therein for prevent moisture from entering into the inside of the flashlight between the present invention and the threaded end of the flashlight.

### DETAILED DESCRIPTION OF THE INVENTION

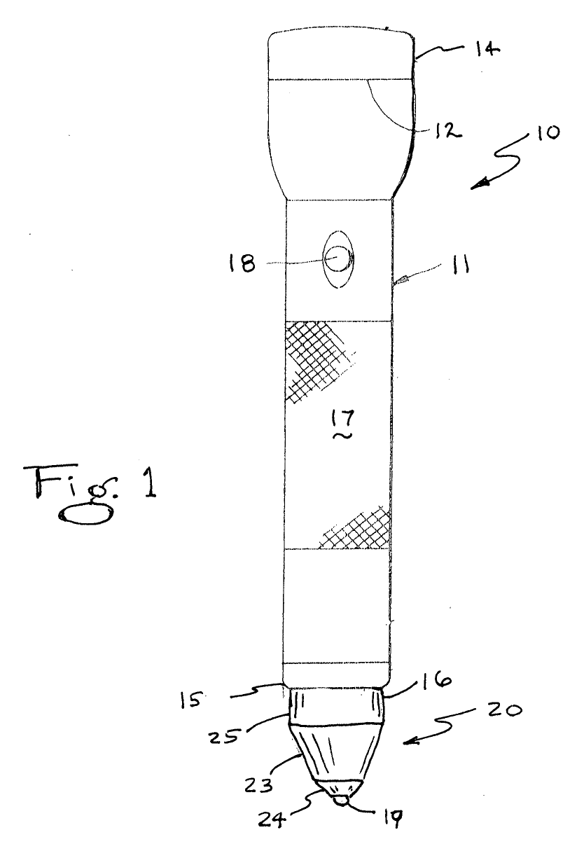

With continuing reference to the drawings herein, and, with special emphasis now to FIG. 1, there is shown and described herein one preferred embodiment using the present invention; namely, a flashlight, generally indicated at 10, comprising a handle 11, a light source 12, and the end cap 13 embodying the glass breaking capability The handle 11 has a first end 14 to which the light source 12 is mounted and a second end 15 to which the end cap 16 is mounted. Typically, the light source 12 and the end cap 16 are both threadably mated to the opposite ends 14 and 15, respectively.

The flashlight 10 typically has a manual gripping portion 17 located circumferencially and mediately disposed about the handle 11 and a switch 18 for turning the light source 12 of the flashlight 10 on and off. The batteries (not shown) that power the flashlight 10 are contained inside the handle 11 and can be inserted or removed and replaced by screwing off the end cap 16. A switch 18 is typically mounted on the handle 11 to turn the light source 12 on and off. Thus, other than the end cap 16, which is modified as described in greater detail below, the flashlight 10 is intended to be and can be any of a number of commercially available flashlights that are in widespread use.

The particular flashlight 10 depicted is one available from Mag Lite of Ontario, Calif. a flashlight 10 that is in widespread use and often carried by law enforcement and other emergency services personnel. Nevertheless, it should be clearly noted that the present invention, generally indicated at 20, could be adopted by modifying the end caps of flashlights made by other manufacturers, such as Streamlight, Inc. of Norristown, Pa. or even by developing a new flashlight to carry the specially designed end cap of the present invention, generally indicated at 20.

One of the primary features of the present invention 20 is to act as a replacement for the end cap located at 15 in FIG. 1 which comes with the flashlight 10 and is used to contain the batteries (not shown) within the flashlight 10. Once the end cap of the flashlight 10 is replaced by the present invention which is referred to by the inventor herein as an escape cap 20.

With special reference now to FIG. 2 there is shown and illustrated the top view of the escape cap generally indicated at 20. As shown, there is a small metal ball 19 (also shown in FIGS. 1, 3, and 4) which is securely mounted in a receptacle 26 drilled in the end of the apex 21 of the external surface 22 of the conically-contoured exterior surfaces 23 and 24. The base 25 of the escape cap 20 is noted also in FIG. 2.

The key element of the present invention is the use of a metal ball 19 typically made of a hardened stainless steel material such as used to make a ball bearing mounted in the apex 21 of the conically-contoured body of the escape cap 20. The use of this metal ball 19 eliminates the use of a sharpened pointed apex 21 which can cut and tear into one' clothing or skin while using the flashlight 10. The metal ball 19 is used to impact a glass surface to break the glass window or windshield such as found in a motor vehicle or the like in order to allow the driver or passenger inside the vehicle to enter or exit therefrom in the event of an emergency or when the window cannot be otherwise moved up or down.

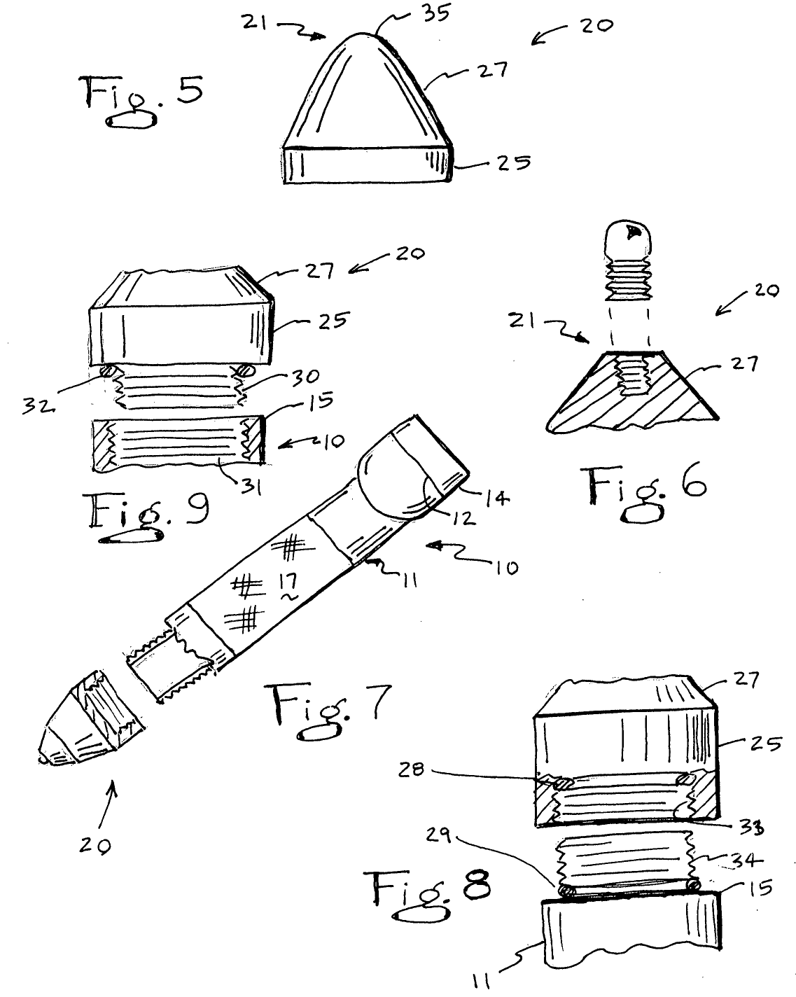

While there is noted in this preferred embodiment of the invention herein, it should be noted that the use of dual conically contoured external surfaces 23 and 24 are shown, the use of a single conically contoured external surface 27, such as shown in FIGS. 5, 6, 8 and 9 can be used with similar success and use, that is, to break a glass surface. However, it should be noted that the use of a single conically contoured external surface 27 may increase the depth of the escape cap 20. The use of dual conically contoured external surfaces 23 and 24 will help to shorten the depth of the escape cap 20, and reduce the added weight of the escape cap 20 and reduce the amount of material needed to form the escape cap 20 thereby effectuating a material cost reduction.

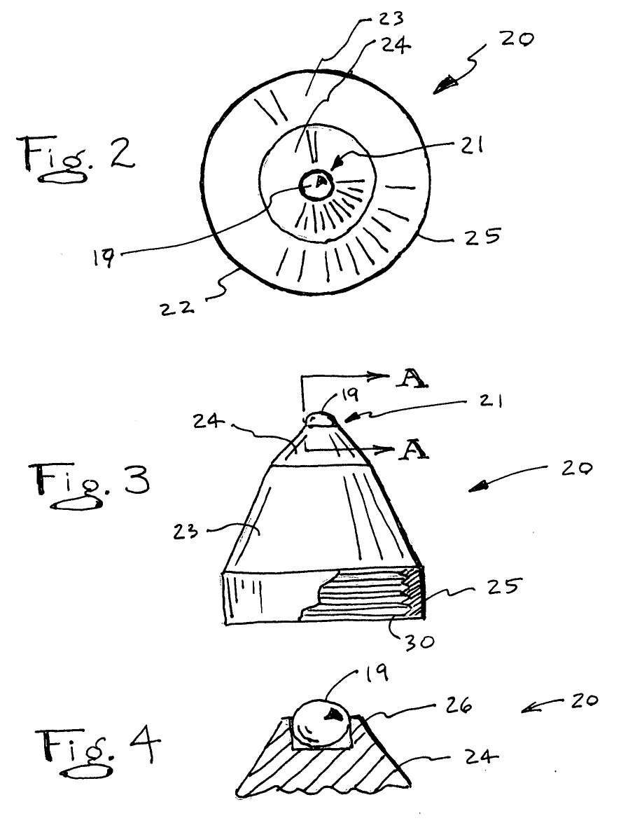

In FIG. 3, there is shown a vertical elevational view of the escape cap 20 illustrated with dual conically contoured external surfaces 23 and 24.

In FIG. 4 there is shown an enlarged cutaway view taken along Plane A-A of FIG. 3 depicting the metal ball 19 mounted in the apex 21 and matingly mounted and secured in the receptacle 26 by press-fitting the ball 19 into the receptacle 26. The base 25 of the escape cap 20 is shown with an internal threaded portion 30 which is adapted to be threadably mated with the threaded end of the flashlight 10 to replace the end cap that originally came with the flashlight 10.

As shown and illustrated in FIG. 5 there is shown a single conically contoured external surface 27 of another embodiment of the escape cap 20 with a base 25 and an apex 21. The apex 21 is rounded and does not come to a point. The rounded portion provides a single tangential point of contact with the glass surface desired to be broken just as a pointed apex will accomplish, but the rounded portion 35 enhances the safe use of the escape cap 20 in combination with the flashlight 10 thereby eliminating the need for a protective cap or cover to be mounted over the sharp pointed apex as noted in other prior art combinations such as noted in U.S. Pat. No. 6,199,997 issued to Outsen. The elimination of the sharp pointed apex substantially reduces the likelihood of the combination being used to penetrate the flesh of a person or an animal whether intended or unintended.

FIG. 7 is an assembly view of the flashlight 10 and the escape cap 20.

As noted in FIG. 8, there is shown an escape cap 20 having a base 25 with an internal threaded portion 33 adapted to threadably mate with the threaded portion 34 of the end 15 of the handle 11 of the flashlight 10.

Turning now to FIG. 9, there is shown an alternative of the escape cap 20 having a single conically contoured external surface 27, and having, as an alternative, an exterior threaded portion 30 adapted to be threadably mated with the complementary threaded portion 31 of the end 15 of the flashlight 10. An O-ring seal 32 is mounted to the escape cap 20 at the junction of the base 25 and the threaded portion 30 to seal out fluids and the like from entering or leaving the inside of the flashlight 10.

While various embodiments of this invention have been shown and described, it would be apparent to those skilled in the art that many more modifications are possible without departing from the inventive concept herein. Therefore, those skilled in the art should realize that variables may be adjusted as necessary to provide a desired effect. It is therefore to be understood that within the scope of the appended claims, this invention may be practiced otherwise than as specifically described.

Although the present invention has been described in accordance with the embodiments shown, one of ordinary skill in the art will recognized that there could be variations of the embodiment and those variations would be within the spirit and scope of the present invention. Further, those skilled in the art should realize that variables may be adjusted as necessary to provide one or more of the desired effects enumerated and described elsewhere herein. as one of ordinary skill in the art readily recognizes, that any number of parameters can be utilized and their use would be within the spirit and scope of the present invention. It is therefore to be understood that within the scope of the appended claims, this invention may be practiced otherwise than as specifically described. Accordingly, many modifications may be made by one of ordinary skill without departing from the spirit and scope of the present invention, the scope of which is defined and limited only by the following claims.

What I claim as my invention is:

1. A device adapted to be removably secured to the end of a rod comprising:
(a) a base portion;
(b) an apex portion having a smaller diameter than the diameter of the base portion; and
(b) attachment means for securing the cone to one end of the rod.

2. The device of claim 1 wherein the base portion and the apex portion of the device forms a conically-shaped exterior surface about the body.

3. The device of claim 1 wherein the base portion has a threaded portion about the exterior thereof.

4. The device of claim 3 whereby the threaded portion of the base portion is adapted to be removably secured to the end of the rod.

5. The device of claim 4 whereby the end of the rod includes a recessed portion having a threaded portion therein adapted for threadably mating with the threaded portion about the exterior of the base portion.

6. The device of claim 1 whereby the base portion includes:
(a) a recessed portion; and
(b) a threaded portion about the recessed portion.

7. The device of claim 6 whereby the threaded portion about the recessed portion of the base portion is adapted to be removably secured to the end of the rod.

8. The device of claim 7 whereby the end of the rod includes a threaded portion about the exterior thereof and adjacent to the end thereof adapted for threadable engagement with the threaded portion about the recessed portion of the base portion.

9. The device of claim 4 further comprising fluid sealing means operably disposed between the base portion and the end of the rod.

10. The device of claim 9 wherein the fluid sealing means is an O-ring seal.

11. The device of claim 10 wherein the O-ring seal is made of rubber.

12. The device of claim 10 wherein the O-ring seal is made of neoprene rubber.

13. The device of claim 8 further comprising fluid sealing means operably disposed between the base portion and the end of the rod.

14. The device of claim 13 wherein the fluid sealing means is an O-ring seal.

15. The device of claim 14 wherein the O-ring seal is made of rubber.

16. The device of claim 15 wherein the O-ring seal is made of neoprene rubber.

17. The device of claims 1-16, inclusive, wherein the rod is cylindrical body.

18. The device of claims 1 and 2 wherein the apex portion further comprises a curved surface on the apex portion.

19. The device of claims 1 and 2 wherein the apex portion includes:
(a) a receptacle having a wall with a rimmed portion thereabout formed in the apex portion; and
(b) an element formed of material harder than the material forming the device, said element having a body longer than the depth of the receptacle and is adapted to be disposed in intimate engagement with the wall of the receptacle when mated therewith to fixedly retain said element therein and protruding beyond the lip of the wall of the receptacle.

20. The device of claim 19 wherein the receptacle is circularly shaped.

21. The device of claim 20 wherein the device is formed of aluminum metal.

22. The device of claim 20 wherein the element is ball-shaped.

23. The device of claim 22 wherein the ball-shaped element is formed of steel.

24. The device of claim 1 wherein the outer surface of the device disposed mediately between the base and the apex comprises a double truncation to shorten the distance between the base portion and the apex portion while maintaining the sharper angle of the surface of the device below the apex portion.

25. The device of claim 19 further comprising means for threadably engaging the element with the receptacle formed in the apex.

26. The device of claim 25 wherein the means for threadably engagement comprises:
(a) a threaded female portion about the inside wall of the receptacle formed in the apex; and
(b) a complementary threaded male portion about the exterior of the element adapted to be threadably mated with threaded female portion about the inside wall of the receptacle formed in the apex the device.
